(19) United States
(12) Patent Application Publication
(10) Pub. No.: US 2024/0319857 A1
(43) Pub. Date: Sep. 26, 2024

(54) Graphically Adaptive Vehicle User Interface Apparatus and Method

(71) Applicant: Bayerische Motoren Werke Aktiengesellschaft, Muenchen (DE)

(72) Inventor: Etienne Iliffe-Moon, Menlo Park, CA (US)

(21) Appl. No.: 18/610,781

(22) Filed: Mar. 20, 2024

(30) Foreign Application Priority Data
Mar. 20, 2023 (DE) 10 2023 106 898.9

(51) Int. Cl. G06F 3/04845; G06F 3/0488; G06T 11/00

(52) U.S. Cl. CPC G06F 3/04845; G06F 3/0488; G06T 11/00; G06T 2200/24

(57) ABSTRACT

A user interface for a vehicle includes an imaging device, a sensing device, and a data processing device. The imaging device is configured to display a virtual image in an image plane in an environment of the user interface. The sensing device senses a user input in relation to the image plane. The data processing device is adapted to control the imaging device and to obtain the user input from the sensing device. The imaging device includes a display device adapted to emit light in response to a control signal from the data processing device and an optics device configured to display the virtual image based the emitted light. The data processing device is adapted to control the display device to graphically adapt the virtual image in response to the user input.

This application claims priority to German Patent Application No. 102023106898.9 filed on Mar. 20, 2023, the disclosure of which is incorporated in its entirety by reference herein.

### TECHNICAL FIELD

The present disclosure relates to a user interface for a vehicle, to a vehicle, to a method of operating a user interface for a vehicle, and to a computer program.

### Background

A virtual and/or holographic image is an important feature of a modern user interface. Such an image appears to float in a space, e.g., in an image plane in front of the user interface, and may be viewed by a user.

A so-called “parity mirror” is a device that uses an optical layer composed of a high-density array of micro-mirrors. The micro-mirrors form a virtual image that appears to float in a mid-air range above the parity mirror, when viewed within an appropriate eye box, i.e., a volume from which a user may look at the parity mirror. The eye box may be defined by hardware conditions.

It is known to sense the position and/or geometry of a finger of a user in the 3-dimensional space. This may serve as an input to deform the virtual image being delivered by the device.

JP 2022-129473 A discloses an aerial image display device which, when a user places his/her finger on a position of an aerial image, gives him/her such a sense that input operation is performed by contacting with the aerial image, so as to facilitate the input operation. The aerial image display device includes: a display unit; an optical element for forming an image displayed on the display unit which is provided on one face side in the air on the other face side; a detection unit for detecting a position of an object near the aerial image formed by the optical element; and a drive unit for moving the optical element. The drive unit moves the optical element according to the position of the object, which has been detected by the detection unit.

Thus, in the prior art, the virtual image is deformed by a mechanical motion of the optical element. This requires sensitive mechanical components.

The impression that such a device may achieve may be disturbed when the user intends to “touch” the image, i.e., when the finger is coincident with the virtual image plane, and may move beyond the image, i.e., when the finger passes through and/or beyond the virtual image plane. When a user attempts to touch on or beyond the virtual image and/or plane the finger passes through the image being occluded by the finger. This may create an effect or disjoint in the user perception that may even be disconcerting and disorienting, since the user's brain is cognitively trying to resolve and make sense of the image the user is seeing in relation to the finger.

In the light of the prior art, the object of the present disclosure is to provide a contribution to the prior art. In particular, it is an object of the disclosure to provide an improved reaction of a virtual image to a user input.

### SUMMARY

The object is achieved by the features of at least some embodiments of the disclosure.

According to an aspect of the present disclosure, a user interface for a vehicle is provided. Therein, the user interface comprises: an imaging device to display a virtual image in an image plane in an environment of the user interface, a sensing device for sensing a user input in relation to the image plane, a data processing device adapted to control the imaging device and to obtain the user input from the sensing device, wherein the imaging device comprises a display device adapted to emit light in response to a control signal from the data processing device and an optics device to display the virtual image on the basis of the emitted light, and the data processing device is adapted to control the display device to graphically adapt the virtual image in response to the user input.

The user interface comprises the imaging device. The imaging device comprises the display device and the optics device. The display device is adapted to emit light, i.e., to convert electric energy into light. The display device may be controlled by the control signal from the data processing device. The optics device may be static. The image may be adapted, i.e., manipulated, by controlling the display device. Thus, controlling the optics device may be dispensed with. The disclosure has realized that the virtual image may be manipulated by controlling the display device accordingly.

By controlling the display device to adapt the virtual image, a more versatile adaption of the virtual image within the image plane may be achieved. Therein, the image plane may remain constant when the virtual image is adapted. In contrast, by moving an optic element, the image plane may be moved, but the image within the image plane remains constant.

The sensing device is adapted to sense the user input in relation to the image plane. I.e., the sensing device may sense one or more fingers of the user in the vicinity of the image plane, e.g., in front of the user interface. Therein, a position and/or movement of the finger relative to the image plane may be interpreted as the user input.

In accordance with at least one embodiment described herein, it is possible to provide a user interface, wherein the illusion and/or a perception of the virtual image by the user, even upon an intention to touch the virtual image and a corresponding gesture as the user input, is maintained. The adaption may create a visual effect that may correspond with the expected perception of the user, as if the virtual image was a real physical object—for example a canvas painting that is being deformed and/or stretched when the user's finger pushes on it. This may maintain the illusion of the virtual image when the user effectively interacts with the virtual image by touch upon or beyond the image plane. The result may be a mid-air virtual image that provides user feedback to finger/hand gestures in 3-dimensional space as user input.

Optionally, graphically adapting the virtual image comprises a scaling, a distortion and/or a displacement of the virtual image. Therein, the adaption and each of the scaling, the distortion and/or the displacement may be performed locally, i.e., in relation to a section of the virtual image. This may create enhanced visual effects and may enable an improved feedback by the user interface to user input.

Optionally, the data processing device is adapted to graphically adapt the virtual image in dependence on a threshold condition relating to a distance between the image plane and the user input. Therein, the distance between the image plane and the user input may be a distance between the image plane and a finger of the user and/or between the image plane and a target that the finger intends to touch. The distance may be efficiently determinable by the sensing device and the threshold condition enables a well-defined behavior of graphically adapting the virtual image.

Therein, the virtual image may be graphically adapted if the distance undercuts a threshold and remain unchanged if the distance exceeds the threshold.

Optionally, the data processing device is adapted to control the display device to graphically adapt the virtual image relating to a lateral distance between the image plane and the user input. Therein, the lateral distance may be a distance in a direction orthogonal to the image plane. E.g., the image plane may be elongated in a X-Y Plane, with orthogonal directions X and Y and the lateral distance is measured in Z-direction being orthogonal to each of the X-direction and Y-direction. This may enable a user feedback by the user interface that is in accordance with an expectation of depth perception by the user.

Optionally, the data processing device is adapted to graphically adapt the virtual image in real-time and/or during the user input is sensed. This may enable a dynamic feedback of the user interface to the user input. Therein, the sensing device may track one or more fingers, i.e., position and/or movement, as the user input. According to the sensed tracking, the virtual image may be graphically adapted in real-time.

Optionally, the sensing device is adapted to sense one or more fingers as the user input. This may enable sensing a variety of gestures, e.g., by one finger such as tap, double tap, pinch and/or swipe, and/or by more than one finger, e.g., rotate.

Optionally, the virtual image is context-related, dynamic and/or time-dependent. The virtual image may represent a context menu which may be adapted based on the user input. The virtual image may be dynamic and/or time-dependent, e.g., an animation and/or a movie.

According to an aspect of the disclosure, a vehicle is provided that includes the user interface as described above. Therein, the user interface may comprise one or more optional features as described above to achieve a technical effect associated therewith.

The user interface may be applied elsewhere, e.g., as a user interface for a consumer device, i.e., being comprised by the consumer device.

According to an aspect of the disclosure, a method of operating a user interface for a vehicle is provided. Therein, the method comprises: displaying a virtual image in an image plane in an environment of the user interface by emitting light in response to a control signal and displaying the virtual image on the basis of the emitted light, sensing a user input in relation to the image plane, and graphically adapting the virtual image in response to the user input. Therein, the method may be adapted to realize one or more features as described above with reference to the user interface to achieve a technical effect corresponding thereto.

According to another aspect, a computer program includes instructions which, when the program is executed by a processor, causes the processor to carry out the method as described above. Optionally, the computer program comprises instructions to realize optional features and/or steps of the method as described above to achieve a technical effect corresponding thereto.

In other words, the above may be summarized in relation to a non-limiting example as follows: The disclosure relates to maintaining the illusion of a virtual image. An apparatus and method that involves one or more external sensors (a TOF or Lidar, RGB or IR camera, capacitive sensor, radar, ultrasound sensor, etc.) to accurately determine the positions of one or more fingers is provided. The system normally displays a virtual image (static or dynamic) or GUI on the image plane. The position of the user's finger(s) may be detected and tracked in 3D space, in real time. When the finger position is within a threshold distance (Z depth axis, e.g. +0.5 mm, 0 mm, −0.5 mm) about the virtual plane the system begins to adapt the virtual image. As the finger(s) moves beyond the virtual plane the system further adapts the virtual image in some proportion or scaling factor related to the Z-depth position and/or movement of the finger. The adaption of the virtual image may include a graphical effect that is for example a distortion, displacement and/or manipulation of the image or GUI. The adaption may be linear or non-linear across the longitudinal or transverse extension (X and Y axes) of the virtual image. The adaption creates a visual effect that corresponds with the expected perception of the user, as if the virtual image was a real physical object—for example a canvas painting that is being deformed or stretched when the user's finger(s) push on it. This approach therefore maintains the illusion of the virtual image when the user effectively “interacts” with the virtual image by touch upon or beyond the virtual plane. The sensor(s) and system may track finger position and motion to achieve this. The above description applies for example if a user is exploring a virtual image (non-GUI static image (photo, graphic, etc.) or dynamic imagery (movie, animation, etc.; photographic, graphical, etc.) for display purposes only; e.g. not a “touchscreen”). This approach may also be applied to dynamic and interactive content/imagery, such as a GUI. Sensing the position and/or movement of the finger may additionally enable the GUI to be adapted as GUI objects or affordances (elements, buttons, sliders, etc. that primarily have a Z-direction adaption or secondarily/additionally an adaption along the X and Y axes. The system may be used to track and determine finger gestures and provide an interaction response that results in the adaption of the GUI to the user gesture input. The result is a mid-air virtual image that provides user feedback to finger/hand gestures in 3-dimensional space (about or behind the virtual plane/image; e.g. in −Z space). The system described above comprises one or more sensors. The system tracks the position, movement and/or gestures of one or more fingers relative to the virtual image plane. The system adapts the virtual image or GUI according to the finger position and/or movement at a threshold Z-Axis position and into the −Z depth past the virtual plane. The adaption effect may be any visual, graphical or simulated distortion, stretching, deformation, movement, etc. The system may provide user feedback to finger/hand gestures made in 3D space relative to the virtual plan (e.g. tap, double tap, pinch, etc.; single or multiple fingers). Optionally, the gesture has a component that is in the Z axis, but not limited to Z-axis motion. For example, a gesture that through the Z-axis motion/position may lead to an adjustment in level (audio, temperature, zoom, etc.), change in state (on/off, active/deactivate, etc.), change in context (context menu, etc.).

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows schematically a vehicle according to an aspect of the disclosure;

FIG. 2 shows schematically a user interface according to an aspect of the disclosure;

FIG. 3 shows a perspective view of an example of a user interface according to an aspect of the disclosure; and

FIG. 4 shows schematically steps of a method according to an aspect of the disclosure.

### DETAILED DESCRIPTION

In the following embodiments are described with reference to Figures, wherein the same reference signs are used for the same objects throughout the description of the figures and wherein the embodiment is just one specific example for implementing the disclosure and does not limit the scope of the disclosure as defined by the claims.

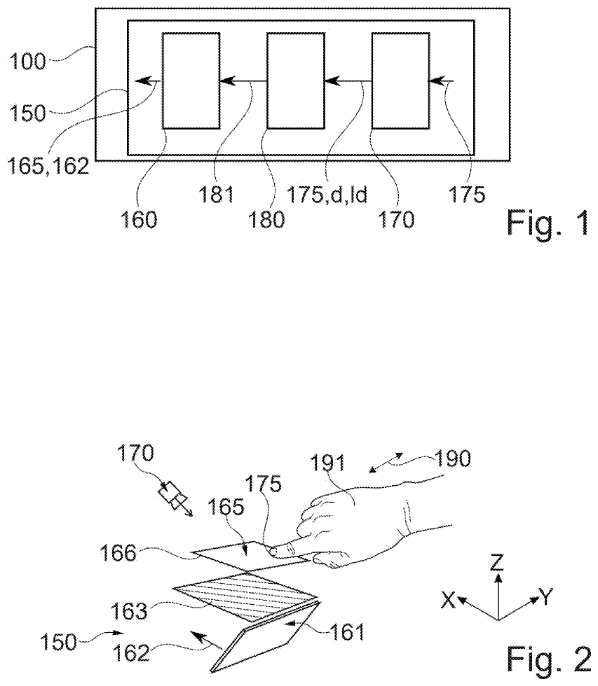

FIG. 1 shows schematically a vehicle 100 according to an aspect of the disclosure. A user 191 (not shown in FIG. 1) may be present in the vehicle 100. The vehicle 100 comprises a user interface 150 to provide an interface between the user 191 and the vehicle 100. The user 191 may control the user interface 150 and perceive information from the user interface 150.

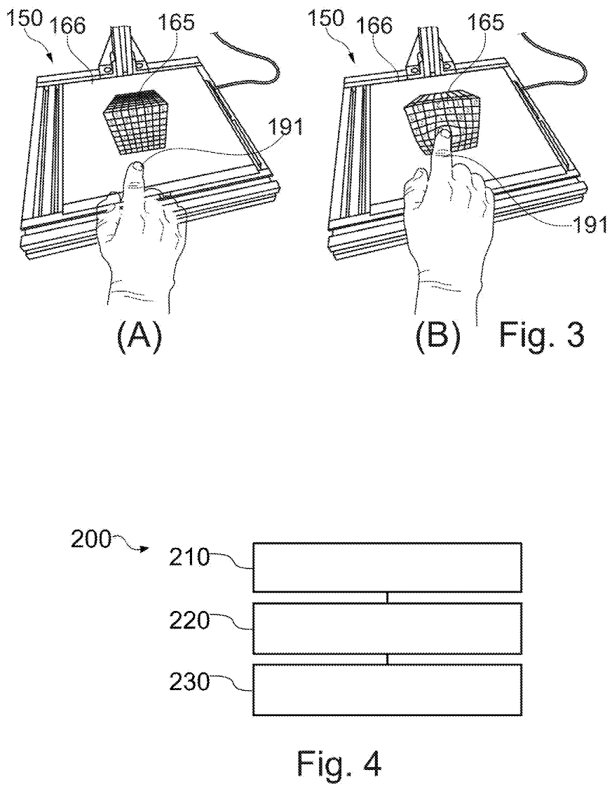

To enable the user 191 to perceive visual information from the user interface 150, the user interface 150 comprises an imaging device 160 to display a virtual image 165 in an image plane 166 in an environment of the user interface 150 (see FIGS. 2 and 3). The user interface 150 may relate to a front or rear seat of the vehicle 100 and the image plane 166 is arranged within the vehicle 200 so that the user 191 sitting on a seat may visually perceive the virtual image 165. The user interface 150 is adapted to present the virtual image 165 as a mid-air image that exists on the virtual image plane 166 floating in the air in a spatial relation to the user interface 150. The user interface 150 is a graphical user interface, GUI.

To enable a control of the user interface 150 by the user 191, the user interface 150 comprises a sensing device 170 for sensing a user input 175 in relation to the image plane 166. The sensing device 170 is for example based on a stereoscopic RGB camera, lidar, infra-red sensing, capacitive sensing, radar, ultrasound sensing. The sensing device 170 is adapted to sense the user 191, e.g., one or more fingers of the user 191. The sensing device 170 is adapted to sense the one or more fingers as the user input 175. Therein, the sensing device 170 is adapted to sense the position and/or movement of the user 191 to track the user 191. The position and/or movement of the user 191 is interpreted as the user input 175.

The user interface 150 comprises a data processing device 180 adapted to control the imaging device 160 and to obtain the user input 175 from the sensing device 170. I.e., the data processing device 180 and the imaging device 160 are communicatively connected with each other so that the data processing device 180 may send a control signal 181 to the imaging device 160; the data processing device 180 and the sensing device 170 are communicatively connected with each other so that the data processing device 180 may receive the user input 175 from the sensing device 170.

The imaging device 160 comprises a display device 161 adapted to emit light 162 in response to the control signal 181 from the data processing device 180 and an optics device 163 to display the virtual image 165 on the basis of the emitted light 162 (see FIG. 2).

The data processing device 180 is adapted to control the display device 161 to graphically adapt the virtual image 165 in response to the user input 175. Therein, graphically adapting the virtual image 165 comprises a scaling, a distortion and/or a displacement of the virtual image 165. The adaption may be linear or non-linear across the longitudinal or transverse of the virtual image 165.

The data processing device 180 is adapted to graphically adapt the virtual image 165 in dependence on a threshold condition relating to a distance d between the image plane 166 and the user input 175. The threshold relates to a threshold distance, for example of 0.5 mm. If the threshold distance is undercut by the distance d, the threshold condition is satisfied and the virtual image 165 is graphically adapted. If the threshold distance is exceeded by the distance d, the threshold condition is not satisfied and the virtual image 165 remains unadapted.

The data processing device 180 is adapted to control the display device 161 to graphically adapt the virtual image 165 relating to a lateral distance Id between the image plane 166 and the user input 175. Therein, the lateral distance Id relates to a distance in a lateral direction Z (see FIG. 2).

The data processing device 180 is adapted to graphically adapt the virtual image 165 in real-time and/or during the user input 175 is sensed. The virtual image 165 is context-related, dynamic and/or time-dependent. Sensing the position/movement of the finger enables the user interface 150 to graphically adapt the virtual image 165 as GUI objects or affordances, such as elements, buttons, sliders, etc. which are graphically adapted to meme a physical interaction with the respective affordance. For example, a virtual image 165 representing a button may be graphically adapted in the lateral direction Z to indicate pressing the button; a virtual image 165 representing a slider may be graphically adapted in a transverse direction X, Y (see FIG. 2) within the image plane 166 to indicate sliding the slider.

FIG. 2 shows schematically a user interface 150 according to an aspect of the disclosure. FIG. 2 is described under reference to FIG. 1.

FIG. 2 shows the display device 161 being adapted to emit light 162 and the optics device 163 to display the virtual image 165 on the basis of the emitted light 162.

The display device 161 may comprise a pixel matrix with individually controllable pixels and an illumination. The illumination may illuminate the pixel matrix which transmits the light 162 selectively to propagate to the optics device 163. The optics device 163 achieve that the light 162 forms the virtual image 165.

The image plane 166 defines two transverse directions X, Y and a lateral direction Z. The image plane 166 is arranged within a plane being defined by the transverse directions X, Y. The lateral direction Z is perpendicular to each of the transverse directions X, Y.

The image plane 166 is parallel to the optics device 163 that may represent the surface of the user interface 150. Thus, a distance d and/or a lateral distance Id relative to the image plane 166 relates to a distance and/or lateral distance, respectively, to the user interface 150. The lateral direction Z represents a depth and the lateral distance Id is related to the lateral direction Z.

A user 191, viewing along a line of sight 190 perceives the virtual image 165 and the image plane 166 to float in a distance in the lateral direction Z above the optics device 163.

FIG. 3 shows a perspective view of an example of a user interface 150 according to an aspect of the disclosure. FIG. 3 is described under reference to FIGS. 1 and 2.

FIG. 3 shows two potentially consecutive views of the user interface 150. Therein, in FIG. 3(A), the distance d between the user 191 and the image plane 166 is comparatively large, i.e., larger than the threshold. The virtual image 165 remains constant and is not adapted. In FIG. 3(B), the distance d between the user 191 and the image plane 166 is comparatively small, i.e., smaller than the threshold. The virtual image 165 is locally graphically adapted, i.e., distorted, in response to the user input 175 by the user 191, i.e., according to the position of the finger of the user 191.

FIG. 4 shows schematically steps of a method 200 according to an aspect of the disclosure. The method 200 is a method 200 of operating a user interface 150 for a vehicle 100. Such a user interface 150 and vehicle 100 are described with reference to FIGS. 1 to 3. FIG. 4 is described under reference to FIGS. 1 to 3.

In FIG. 4, the method 200 comprises: displaying 210 a virtual image 165 in an image plane 166 in an environment of the user interface 150 by emitting light 162 in response to a control signal 181 and displaying the virtual image 165 on the basis of the emitted light 162.

The method 200 comprises sensing 220 a user input 175 in relation to the image plane 166.

The method 200 comprises graphically adapting 230 the virtual image 165 in response to the user input 175.

### LIST OF REFERENCE SIGNS (PART OF THE DESCRIPTION)

100 vehicle
150 user interface
160 imaging device
161 display device
162 light
163 optics device
165 virtual image
166 image plane
170 sensing device
175 user input
180 data processing device
181 control signal
190 line of sight
191 user
200 method
210 displaying
220 sensing
230 graphically adapting
d distance
Id lateral distance
X transverse direction
Y transverse direction
Z lateral direction

1. A user interface for a vehicle, comprising:
an imaging device configured to display a virtual image in an image plane in an environment of the user interface,
a sensing device configured to sense a user input in relation to the image plane,
a data processing device adapted to control the imaging device and to obtain the user input from the sensing device, wherein
the imaging device comprises a display device adapted to emit light in response to at least one control signal from the data processing device and an optics device configured to display the virtual image based on the emitted light, and
the data processing device is adapted to control the display device to graphically adapt the virtual image in response to the user input.

2. The user interface as claimed in claim 1, wherein graphically adapting the virtual image comprises at least one of the group consisting of a scaling of the virtual image, a distortion of the virtual image, and a displacement of the virtual image.

3. The user interface as claimed in claim 2, wherein the data processing device is adapted to graphically adapt the virtual image in dependence on a threshold condition relating to a distance between the image plane and the user input.

4. The user interface as claimed in claim 3, wherein the data processing device is adapted to graphically adapt the virtual image in real-time as the user input is sensed.

5. The user interface as claimed in claim 1, wherein the data processing device is adapted to graphically adapt the virtual image in dependence on a threshold condition relating to a distance between the image plane and the user input.

6. The user interface as claimed in claim 1, wherein the data processing device is adapted to control the display device to graphically adapt the virtual image corresponding to a lateral distance between the image plane and the user input.

7. The user interface as claimed in claim 1, wherein the data processing device is adapted to graphically adapt the virtual image in real-time as the user input is sensed.

8. The user interface as claimed in claim 1, wherein the sensing device is adapted to sense one or more fingers as the user input.

9. The user interface as claimed in claim 8, wherein the sensing device is adapted to sense a position of the one or more fingers, and wherein the data processing device interprets the position as the user input.

10. The user interface as claimed in claim 8, wherein the sensing device is adapted to sense a movement of the one or more fingers, and wherein the data processing device interprets the movement as the user input.

11. The user interface as claimed in claim 10, wherein the sensing device is adapted to sense a position of the one or more fingers, and wherein the data processing device interprets the position and the movement as the user input.

12. The user interface as claimed in claim 1, wherein the virtual image is context-related.

13. The user interface as claimed in claim 1, wherein the virtual image is dynamic or time-dependent.

14. The user interface as claimed in claim 1, wherein graphically adapting the virtual image comprises a distortion of the virtual image.

15. The user interface as claimed in claim 14, wherein the data processing device is adapted to graphically adapt the virtual image in dependence on a threshold condition relating to a distance between the image plane and the user input.

16. The user interface as claimed in claim 15, wherein the data processing device is adapted to graphically adapt the virtual image in real-time as the user input is sensed.

17. A vehicle comprising the user interface as claimed in claim 1.

18. A method of operating a user interface for a vehicle, wherein the method comprises:
displaying a virtual image in an image plane in an environment of the user interface by emitting light in response to a control signal, and displaying the virtual image on the basis of the emitted light,
sensing a user input in relation to the image plane, and
graphically adapting the virtual image in response to the user input.

19. A computer readable medium story a computer program, the computer program comprising instructions which, when executed by a processor, causes the processor to carry out the method of claim 18.
